(19) United States
(12) Patent Application Publication
(10) Pub. No.: US 2026/0070827 A1
(43) Pub. Date: Mar. 12, 2026

(54) BIORETENTION POND INTEGRATING COLLECTION-FILTRATION-PURIFICATION FUNCTIONS AND APPLICATION THEREOF

(71) Applicant: Jiangsu University, Zhenjiang (CN)

(72) Inventor: Weijuan GENG, Zhenjiang (CN)

(73) Assignee: Jiangsu University, Zhenjiang (CN)

(21) Appl. No.: 19/284,830

(22) Filed: Jul. 30, 2025

(30) Foreign Application Priority Data
Sep. 6, 2024 (CN) 202411255545.7

(51) Int. Cl. C02F 9/00; C02F 1/28; C02F 3/34; C02F 103/00

(52) U.S. Cl. CPC C02F 9/00; C02F 1/281; C02F 3/34; C02F 2103/001; C02F 2201/004; C02F 2203/006

(57) ABSTRACT

A bioretention pond integrating collection-filtration-purification functions and an application thereof are provided. The environment-adaptive bioretention pond integrating collection-filtration-purification functions sequentially includes, from top to bottom, an embedded composite microbial purification layer, a clay adsorption layer, a packing layer, and a gravel drainage layer. According to the unique design of the layers in the bioretention pond, the optimization of structure and function not only solves the problems of conventional systems in treatment efficiency, maintenance cost, environmental adaptability and sustainability, but also improves the overall performance and environmental friendliness of the system, and adapts to the environmental requirements of modern cities and industrial development on efficient water treatment technology.

### CROSS REFERENCE TO THE RELATED APPLICATIONS

This application is based upon and claims priority to Chinese Patent Application No. 202411255545.7, filed on Sep. 6, 2024, the entire contents of which are incorporated herein by reference.

### TECHNICAL FIELD

The present invention relates to the technical field of environmental and ecological restoration, and in particular to a bioretention pond integrating collection-filtration-purification functions and an application thereof.

### BACKGROUND

A schematic diagram of a structure of a conventional bioretention pond is shown in FIG. 1, which sequentially includes a water retention layer, a vegetation and cover layer, a fill layer and a drainage layer from top to bottom. The water retention layer is positioned at a top and directly collects rainwater through surface runoff and rainfall; and the vegetation and cover layer is used to plant various plants and provide preliminary mechanical filtration. The fill layer is used to treat pollutants in the water; and the drainage layer is positioned at a bottom to drain water and support a superstructure.

However, the conventional bioretention pond described above has the following problems:

1. The filtering effect of a single vegetation layer is extremely limited, and the ecological diversity is low, which affects the purification effect and cannot remove complex pollutants. 2. The vegetation and packing layers are easily clogged and need to be replaced in a short period of time, which makes long-term maintenance difficult and costly. 3. For an anti-seepage bioretention pond, geotextile liner is very likely to fail during use, resulting in leakage of pollutants. 4. The hydraulic load is unevenly distributed, and some areas may experience waterlogging or dryness. 5. The ability to purify organic matter and heavy metal ions is extremely low.

### SUMMARY

An objective of the present invention is to provide a bioretention pond integrating collection-filtration-purification functions and an application thereof. The bioretention pond of the present invention may improve the efficiency of sewage and rainwater treatment and enhance environmental adaptability and ecological resilience.

To achieve the above objective, the present invention provides the following technical solutions.

The present invention provides a bioretention pond integrating collection-filtration-purification functions, which sequentially includes: an embedded composite microbial purification layer, a clay adsorption layer, a packing layer and a gravel drainage layer from top to bottom;

the embedded composite microbial purification layer includes a first module layer and a second module layer; the first module layer and the second module layer form corresponding upper and lower layer structures in space; the first module layer is connected to the second module layer by an embedded unit column; the first module layer includes a first microbial colony area, a second microbial colony area and a third microbial colony area arranged in parallel; the second module layer is a fourth microbial colony area; types of microbial species in the first microbial colony area, the second microbial colony area, the third microbial colony area and the fourth microbial colony area are different;
the packing layer includes a first packing layer and a second packing layer which are stacked; and the first packing layer and the second packing layer are different in packing type.

Preferably, the bioretention pond integrating collection-filtration-purification functions further includes a water retention layer and a vegetation cover layer, and the vegetation cover layer and the water retention layer are sequentially stacked on the embedded composite microbial purification layer.

Preferably, when the bioretention pond is an impermeable bioretention pond, a geotextile lining layer is also stacked on the gravel drainage layer.

Preferably, a thickness of the embedded composite microbial purification layer is more than or equal to 40 mm;
the first module layer and the second module both carry microbial species by adopting support plates; and an activated carbon particle layer is laid on a support plate of the first module layer.

Preferably, clay used in the clay adsorption layer is attapulgite and bentonite-based clay.

Preferably, packing materials used in the first packing layer and the second packing layer independently include gravel, bark mulch, biochar, or bentonite.

Preferably, geosynthetic liner used in the geotextile lining layer is a bentonite-based geotextile liner.

The present invention provides an application of the bioretention pond integrating collection-filtration-purification functions according to the foregoing technical solution in new-generation urban rainstorm management.

The present invention provides an environment-adaptive bioretention pond integrating collection-filtration-purification functions, which sequentially includes a water retention layer, a vegetation cover layer, an embedded composite microbial purification layer, a clay adsorption layer, a packing layer, a gravel drainage layer, and a modified geotextile liner (aiming at an impermeable bioretention pond) from top to bottom. According to the unique design of the layers in the bioretention pond of the present invention, the optimization of structure and function not only solves the problems of conventional systems in treatment efficiency, maintenance cost, environmental adaptability and sustainability, but also improves the overall performance and environmental friendliness of the system, and meets the demand for efficient water treatment technology in modern urban and industrialized environments.

Compared with the conventional bioretention pond, the bioretention pond provided by the present invention has the following advantages:

The bioretention pond of the present invention may improve the pollutant removal efficiency, improve the sewage treatment efficiency, and comprehensively treat multiple pollutants. The conventional bioretention pond may be inefficient in treating certain types of pollutants (such as heavy metals or persistent organic pollutants). The present invention enhances the removal capacity of these difficult-to-treat pollutants by introducing an embedded composite microbial purification layer and a clay adsorption layer, combined with the unique layered structure of the microbial purification layer. A unique layered treatment strategy is set, and the targeted microbial flora and clay materials are used in specific layers, so that more effective pollutant decomposition and adsorption are ensured. The bioretention pond of the present invention shows higher efficiency than the conventional bioretention pond in removing organic matter (COD and BOD), nitrogen (N), phosphorus (P) and heavy metals (lead and cadmium). By combining different layers, the treatment process of the conventional bioretention pond is optimized to achieve higher pollutant removal efficiency.

The modular design of the embedded composite microbial purification layer in the bioretention pond of the present invention allows the expansion or reduction of treatment units according to an actual requirement, provides greater flexibility and system scalability, and solves the problem that conventional systems are difficult to adjust according to treatment requirements or environmental changes.

The present invention reduces the negative impact on the environment, promotes ecological balance, and improves the environmental sustainability and ecological resilience of the system by using environmentally friendly materials (such as natural clay), increasing the vegetation layer and optimizing the use of microorganisms. Meanwhile, the present invention combines natural ecological processes and engineering technology to reduce the use of chemical synthetic materials and energy, promotes environmental protection and resource recycling, and provides the dual functions of ecological restoration and landscaping.

The bioretention system of the present invention may operate stably under different environmental conditions, such as temperature changes and pH fluctuations, and may adapt to environmental changes by adjusting the microbial combination and operating conditions in the composite biological layer, thereby avoiding the limitation of environmental conditions on the treatment effect.

The present invention is easy to maintain and replace parts through modular and layered design, and reduces the possibility of system clogging and the complexity of long-term maintenance. Moreover, the modular and flexible design allows the system to be quickly adjusted according to different water treatment requirements and environmental conditions, providing customized solutions, such as increasing the flexibility and adaptability of the system by changing the microbial population or adjusting operating parameters, and improving the stability and adaptability of the system operation. For example, under conditions of temperature changes (5° C. to 35° C.) and pH fluctuations (pH 5-9), the system shows stronger processing capacity and stability than the conventional system.

The replaceable layers and modular design of the bioretention pond of the present invention simplify the maintenance process, reduce the labor and time required for system shutdown or overhaul, reduce maintenance costs, and improve economic benefits; the use of readily available organisms and modified materials reduces dependence on expensive chemicals, further reducing operating costs. This bioretention pond is not only suitable for industrial wastewater treatment, but can also be used for urban stormwater management and agricultural drainage systems, with a wide range of market applications.

### BRIEF DESCRIPTION OF THE DRAWINGS

FIG. 1 is a schematic diagram of a structure of a conventional bioretention pond;

FIG. 2 is a schematic diagram of a cross-sectional structure of a bioretention pond according to an embodiment of the present invention;

FIG. 3 is a schematic diagram of a structure of a packing layer in a bioretention pond according to the present invention; and

FIGS. 4A-4B are schematic diagrams of a structure of an embedded composite microbial purification layer according to the present invention, where FIG. 4A is a cross-sectional view and

FIG. 4B is a top view.

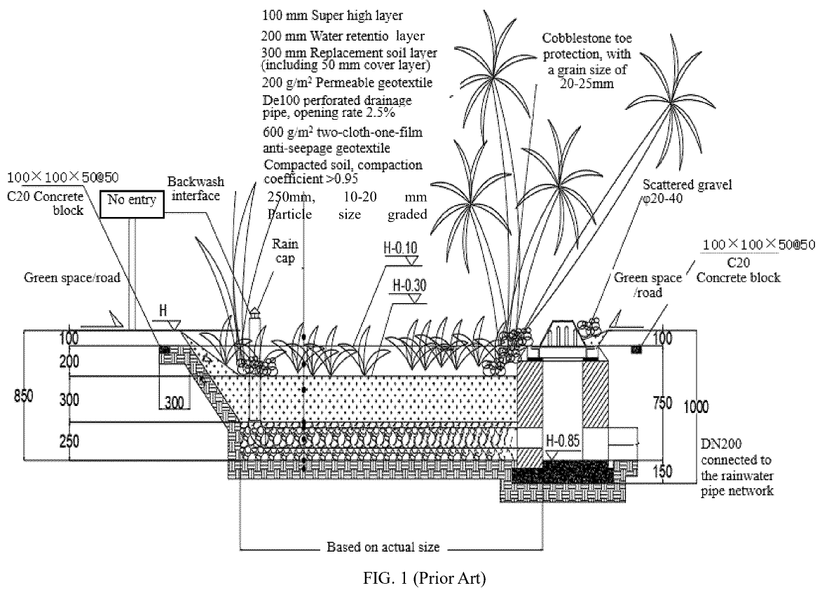

### DETAILED DESCRIPTION OF THE EMBODIMENTS

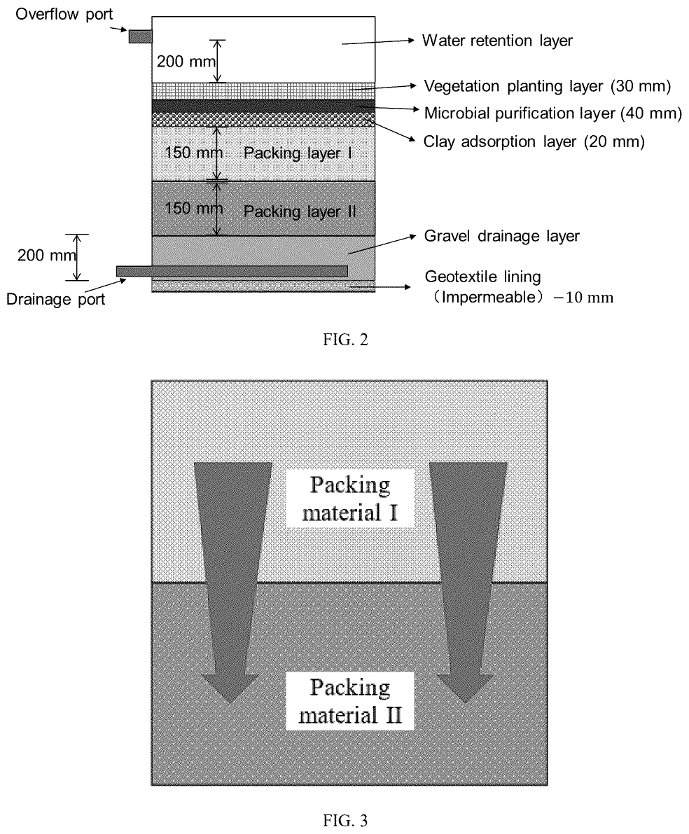

As shown in FIG. 2, The present invention provides a bioretention pond integrating collection-filtration-purification functions, which sequentially includes: an embedded composite microbial purification layer, a clay adsorption layer, a packing layer and a gravel drainage layer from top to bottom;

the embedded composite microbial purification layer includes a first module layer and a second module layer; the first module layer and the second module layer form corresponding upper and lower layer structures in space; the first module layer is connected to the second module layer by an embedded unit column; the first module layer includes a first microbial colony area, a second microbial colony area and a third microbial colony area arranged in parallel; the second module layer is a fourth microbial colony area; types of microbial species in the first microbial colony area, the second microbial colony area, the third microbial colony area and the fourth microbial colony area are different;

the packing layer includes a first packing layer and a second packing layer which are stacked; and the first packing layer and the second packing layer are different in packing type.

In the present invention, the bioretention pond integrating collection-filtration-purification functions further includes a water retention layer and a vegetation cover layer, and the vegetation cover layer and the water retention layer are sequentially stacked on the embedded composite microbial purification layer.

The present invention has no special limitation on the depth of the water retention layer, and the depth of the water level in the water retention layer is designed according to the application environment and geographic factors. In the present invention, the depth below the overflow port in the water retention layer is 200 mm, and the depth may be correspondingly expanded. In an embodiment of the present invention, the depth of the water level in the water retention layer is 20 cm.

The present invention has no special limitation on the water retention layer, which may be set in the manner of a retention pond well known in the art to temporarily store rainwater runoff, especially to reduce rainwater from directly entering the municipal drainage system during heavy rainfall events.

The present invention has no special limitation on the plant species used in the vegetation cover layer, and the plant species well known in the art may be used.

The present invention has no special limitation on the specific thickness of the vegetation cover layer, which may be designed according to the application environment and geographical factors. In an embodiment of the present invention, 20 mm of the vegetation cover layer is used for planting, and the upper height varies according to the characteristics of local vegetation as a ground landscape.

The vegetation cover layer in the present invention not only provides beauty and a natural feel, but also increases the ecological functions of the system: natural filtration, plants may absorb soluble pollutants through root systems, and meanwhile, the root system can promote the growth of microorganisms and enhance the biodegradation effect; ecological restoration: this layer helps to restore ecosystem functions, provides habitats for insects and birds, and increases biodiversity.

In the present invention, a thickness of the embedded composite microbial purification layer is preferably more than or equal to 40 mm.

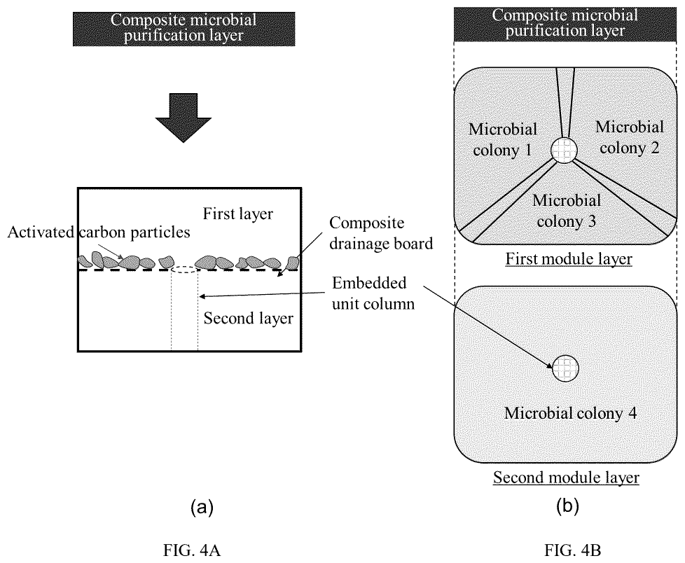

In the present invention, as shown in FIGS. 4A-4B, in the embedded composite microbial purification layer, the first module layer and the second module layer form a corresponding upper and lower structure in space. The first module layer and the second module layer of the present invention preferably adjust a peripheral structure according to different application scenarios. When the embedded series-parallel unit microbial purification module is used alone, it is necessary to set a peripheral plate to form an overall structure; and when the embedded series-parallel unit microbial purification module is placed in other systems for use, there is no need to set a peripheral plate.

The present invention preferably adjusts the sizes of the first module layer and the second module layer according to actual requirements, and the sizes of the two layers do not need to be exactly the same.

The first module layer and the second module layer are connected by embedded unit columns. The present invention has no special limitation on the material of the embedded unit columns, as long as the embedded unit columns can support the weight of the first module layer and the second module layer. In an embodiment of the present invention, the embedded unit columns are preferably made of polyvinyl chloride (PVC). The embedded unit column is used as a support, and the effect of separating the first module layer from the second module layer is achieved.

In the present invention, the first module layer and the second module both carry microbial species by adopting support plates. The support plate is preferably independently a PVC plate, a PLA plate or a PHA plate; and the present invention preferably customizes the support plate according to the usage scenario and cost. The support plate used in the present invention is porous and degradable, which is conducive to the growth and spread of microorganisms, and also complies with the principles of environmental protection and sustainability, thereby reducing environmental pollution and waste disposal problems.

In the present invention, an activated carbon particle layer is preferably laid on the support plate of the first module layer; the thickness of the activated carbon particle layer is preferably 30-50 mm; and the particle size of the activated carbon in the activated carbon particle layer is preferably 2-4 mm. The activated carbon particle layer in the present invention is used for adsorption of organic matter and heavy metals, and can help to evenly distribute water flow, ensuring that the density and thickness of the activated carbon particles are uniform, so as to optimize the adsorption effect. The present invention regularly monitors the adsorption saturation state of the activated carbon particles and determines the replacement frequency according to actual treatment conditions. When the activated carbon particles are replaced, the new and old particles are evenly mixed to maintain stable operation of the system.

In the present invention, the first microbial colony area, the second microbial colony area and the third microbial colony area are carried on the activated carbon particle layer.

The particle size of the attapulgite used in the present invention is preferably 1-2 mm, and the attapulgite is used to treating residual organic matters and heavy metals in water.

In the present invention, the fourth microbial colony area is carried on the lower clay adsorption layer.

The types and the quantities of the microbial species in the first microbial colony area, the second microbial colony area, the third microbial colony area and the fourth microbial colony area are preferably set according to actual application scenarios and the water source to be treated. In an embodiment of the present invention, the number ratio of microbial species in the first microbial colony area, the second microbial colony area and the third microbial colony area is preferably 4:3:3; the laying amount of the fourth microbial colony area is 1×10⁸ CFU.

The microbial agents used in the microbial colony area of the present invention are harmless to animals and plants, are environmentally friendly, do not introduce foreign species, and are helpful to maintain or restore ecological balance.

In an embodiment of the present invention, the microbial species in the first microbial colony area is Pseudomonas putida (used to degrade aromatic hydrocarbon organic matter, such as benzene and toluene); the microbial species in the second microbial colony area is Nitrosomonas europaea (used to oxidize ammonia nitrogen into nitrite); the microbial species in the third microbial colony area is Alcaligenes faecalis (used to treat nitrogen-containing organic matter and provide the system with adaptability to pH fluctuations); and the microbial species in the fourth microbial colony area is Nitrobacter winogradskyi (configured in series with a layer of microorganisms to further oxidize nitrite into nitrate to complete the nitrogen oxidation process). The Pseudomonas putida is responsible for the degradation of organic pollutants and creates a relatively clean environment for subsequent nitrogen and phosphorus treatment; Nitrosomonas spp. and Nitrobacter spp. form an effective continuous action chain of ammonia oxidation and nitrite oxidation to ensure efficient conversion of nitrogen; Alcaligenes faecalis provides the system with adaptability to environmental fluctuations, especially maintaining the activity of other microorganisms when the pH value changes greatly. These four bacterial colonies can coexist, and the modular sewage treatment system constructed can not only efficiently remove a variety of pollutants, but also adapt to the complex and changeable urban rainwater environment, ensuring the stability and sustainability of the treatment system.

The present invention has no special limitation on the source of the microbial agents used in different microbial colony areas, and any commercially available product known in the art may be used. In an embodiment of the present invention, the microbial agents used are specifically derived from ATCC.

In the present invention, according to the embedded composite microbial purification layer, sewage first enters the first module layer, and after being treated by the microbial colony, the sewage treated by the first module layer flows into the second module layer.

The present invention has no special limitation on the manufacturing method of the embedded composite microbial purification layer, which may be constructed using specific materials according to the required structure.

In the embedded composite microbial purification layer of the present invention, each layer uses a specific microbial community for specific pollutants. Different microbial communities are combined and assembled in a “series-parallel” manner by using modular units to achieve synergy. For “series”, different microorganisms have different physiological characteristics and metabolic pathways. The combination of different microorganisms may achieve more comprehensive and efficient pollutant treatment. For “parallel”, the redundant design enables the composite microorganisms to better adapt to different environmental conditions, such as pH value, temperature, and oxygen content, have higher system ecological resilience, and can still maintain effectiveness in a variety of application scenarios. The microbial agents are harmless to animals and plants, are environmentally friendly, do not introduce foreign species, and are helpful to maintain or restore ecological balance. The use of porous and degradable support plates not only facilitates the growth and spread of microorganisms, and also complies with the principles of environmental protection and sustainability, thereby reducing environmental pollution and waste disposal problems. The use of embedded modules has a directional effect. Specific types of microorganisms are selected to treat specific types of pollutants, such as specific types of organic matter, heavy metals, nitrogen and phosphorus. In addition, modular combination assembly technology is simple and flexible to construct, and may be easily expanded or modified based on requirements. The modular design also facilitates maintenance and upgrades and can be customized according to specific application requirements, improving treatment efficiency and environmental adaptability. In the long run, the modular design may reduce operating and maintenance costs, especially when dealing with large-scale or complex pollution problems. The modular design allows the system to be quickly adapted or expanded for specific pollutant loads or remediation goals. Due to the high adaptability and efficiency of this system, the embedded composite microbial module can be applied in a wide range of fields such as urban stormwater management, agricultural drainage treatment, and industrial wastewater treatment.

The characteristics of the embedded composite microbial purification layer in the present invention include: segmented specialization: different microbial flora are designed in different layers, such as separating microorganisms for degrading organic matter from microorganisms for removing nitrogen. This specialization allows each microbial flora to work in an environment that is most suitable for metabolism, improving purification efficiency. Enhanced synergy: Microorganisms with different metabolic pathways are placed in consecutive layers, which can achieve continuous treatment of pollutants during movement, thereby increasing synergy and reducing the accumulation of intermediates. Expandability: Additional modules may be added to treat larger water volumes or different types of wastewater based on requirements. Easy maintenance and replacement: The modular design simplifies maintenance tasks, as individual modules can be removed, repaired or replaced independently without stopping the entire system.

In the present invention, the thickness of the clay adsorption layer is 20 mm; the clay used in the clay adsorption layer is a mixture of attapulgite and bentonite; the present invention has no special limitation on the mass ratio of the attapulgite to bentonite, which can be adjusted according to actual requirements. The present invention has no special limitation on the source of the clay, and any natural clay known in the art may be used. As an environmentally friendly material, natural clay can reduce the negative impact on the ecosystem. Different clays can be customized according to specific water quality conditions and treatment requirements, thereby improving the treatment capacity for diverse pollution sources and adapting to water treatment needs of different scales and types. The clay not only supplies water to the microbial layer and the vegetation cover layer through capillary action during dry periods, but also provides additional pollutant adsorption capacity: 1) Enhanced adsorption capacity: The clay adsorption layer has the ability to adsorb specific pollutants, such as heavy metals and organic pollutants, which helps to reduce pollutants that may be missed by conventional biological treatment; 2) Ion exchange function: The water quality is further purified, especially the removal of phosphorus and nitrogen.

In the present invention, the clay adsorption layer is arranged below the embedded composite microbial purification layer and is used to adsorb and treat specific pollutants such as heavy metals and organic pollutants. The clay adsorption layer is placed between the composite microbial layer and the packing layer to play a “bridging” role. In one aspect, as a carrier of microorganisms, the clay adsorption layer provides a larger specific surface area for microorganisms to attach, thereby enhancing the effect of biological treatment; in another aspect, the clay adsorption layer can effectively adsorb organic matter and heavy metal ions in the water, which helps to remove pollutants in the water, and has a certain ion exchange capacity, which can remove nutrients such as phosphorus and nitrogen in the water to a certain extent.

The present invention has no special limitation on the thickness ratio between the first packing layer and the second packing layer, which may be adjusted according to actual requirements. In an embodiment of the present invention, the thickness ratio is specifically 1:1.

The present invention has no special limitation on the thickness of the packing layer and the thickness of the first packing layer and the second packing layer in the packing layer, which may be adjusted according to actual requirements. In an embodiment of the present invention, the thickness of the packing layer is specifically 30 cm.

In the present invention, the packing materials used in the first packing layer and the second packing layer preferably and independently include gravel, bark mulch, biochar, or bentonite.

The improved packing material used in the present invention is preferably derived from industrial and agricultural waste, which reduces the carbon footprint, embodies the recycling of resources, and reduces the production cost. The setting of the packing layer may achieve the effective removal of pollutants and improve the overall efficiency of the water treatment system. The double-layer packing material combination optimizes the permeability performance, helps to evenly distribute water and effectively treat pollutants, helps to regulate the total amount of runoff, reduces surface water pollution and urban flooding risks, and ensures the long-term and stable operation of the bioretention pond.

The packing layer of the present invention adopts a two-layer “stacked” design (as shown in FIG. 3). Different packing layers may be used to perform specialized treatments on different types of pollutants. For example, the upper layer treats organic matter, and the lower layer treats soluble pollutants and nutrients, thereby improving the overall treatment and filtration efficiency. The “combined” pattern of the packing layers optimizes permeability, helps evenly distribute water and effectively treat pollutants, helps regulate the total amount of runoff, reduces surface water pollution and urban flooding risks, and ensures the long-term stable operation of the bioretention system. According to different working environments, the optimal combination of the packing materials is selected to achieve the highest pollutant removal efficiency and effectively reduce system clogging.

The present invention has no special limitation on the thickness of the gravel drainage layer, which may be adjusted according to the sewage treatment requirements. In an embodiment of the present invention, the thickness of the gravel drainage layer is specifically 20 cm.

In the present invention, the water retention layer is provided with an overflow port; the gravel drainage layer is provided with a drainage port.

In the present invention, when the bioretention pond is an impermeable bioretention pond, a geotextile lining layer is also stacked on the gravel drainage layer. When the bioretention pond is an infiltration-type bioretention pond, no geotextile lining layer is required.

In the present invention, the geosynthetic liner used in the geotextile lining layer is preferably a bentonite-based geoliner, more preferably an anti-seepage geotextile liner, and further preferably a polyacrylamide-modified bentonite geoliner; and the thickness of the geotextile lining layer is preferably 10-20 mm.

The geotextile lining layer of the present invention is used for controlling and purifying runoff, for preventing pollutants from penetrating into groundwater through surface runoff, and for providing high durability of anti-seepage effect. Under long-term erosion from polluted environments, the liner has excellent chemical stability and can maintain a low permeability coefficient, which helps to continuously protect groundwater resources and effectively prevent surface runoff pollution. The use of the geotextile liner in polyacrylamide modified bentonite increases chemical resistance and physical stability, and effectively prevents pollutants from penetrating into groundwater.

The present invention has no special limitation on the construction method of the bioretention pond integrating collection-filtration-purification functions, and the layers can be stacked and arranged based on actual requirements in accordance with methods well known in the art.

Compared with the conventional bioretention pond, the bioretention pond integrating collection-filtration-purification functions of the present invention has significant structural advantages, improves the treatment efficiency, increases the flexibility of the system, and improves the environmental adaptability.

In practical applications, the design and the operation effect of the system and the social and environmental influences thereof may be comprehensively evaluated according to actual requirements, and the bioretention pond integrating collection-filtration-purification functions is upgraded or optimized (such as replacing microorganism colonies and replacing packing materials) so as to improve the efficiency and adapt to new environmental requirements (such as seasonal temperature changes).

The present invention provides an application of the bioretention pond integrating collection-filtration-purification functions according to the foregoing technical solution in new-generation urban rainstorm management. The present invention has no particular limitation on the application method. The application can be performed based on a method well known in the art.

The technical solutions provided by the present invention will be described in detail below with reference to examples, which, however, should not be construed as limiting the scope of the present invention.

In the following examples, the microbial agents used are all from ATCC, and the specific numbers are:
Pseudomonas putida: ATCC 47054;
Nitrosomonas europaea: ATCC 19718;
Alcaligenes faecalis: ATCC 8750; and
Nitrobacter winogradskyi: ATCC 25391.

### Example 1

The rainwater runoff from a certain urban community and its surrounding areas was treated and synthetic rainwater was used. The specific components are shown in Table 1.

Based on the laboratory scale, a small-scale bioretention pond model was constructed with a length, width and height of 2 m, 1 m and 1 m respectively. Water quality tests and microbial activity monitoring were performed regularly to ensure that the system operated effectively according to the design standards.

Each layer of material was layered as follows:

### Design of Bioretention Pond, and the Specific Sizes of Each Layer are Shown in FIG. 2:

A first layer: water retention layer
A second layer: vegetation planting layer

Cattails, rushes and native irises are selected to provide initial solid filtration and landscaping while the plant roots absorb nutrients from the water.
A third layer: embedded composite microbial purification layer

The upper layer microorganisms are Pseudomonas putida, Nitrosomonas europaea and Alcaligenes faecalis, which are used to degrade organic pollutants from residential areas; the lower layer microorganisms are Nitrobacter winogradskyi, which oxidizes nitrite to nitrate.

As shown in FIGS. 4A-4B, the support plate is a PVC plate, the thickness of the activated carbon particle layer is 50 mm; the particle size of the activated carbon in the activated carbon particle layer is 2-4 mm;

The microbial species in microbial colony area 1 is Pseudomonas putida; the microbial species in microbial colony area 2 is Nitrosomonas europaea; the microbial species in microbial colony area 3 is Alcaligenes faecalis; the microbial species in microbial colony area 4 is Nitrobacter winogradskyi; the laying amounts of microbial species in microbial colony area 1, microbial colony area 2, microbial colony area 3 and microbial colony area 4 are 4×10⁸ CFU, 3×10⁸ CFU, 3×10⁸ CFU, and 1×10⁸ CFU, respectively.
A fourth layer: clay adsorption layer

A mixed clay of attapulgite and bentonite (attapulgite is from Gansu Rongwan Technology Co., Ltd., and bentonite is a commercially available nano-bentonite material (Tianjin Huasheng Chemical Reagent Co., Ltd.)) is used to adsorb heavy metals (such as lead and cadmium) and non-biodegradable organic pollutants.
A fifth layer: packing layer

The packing layer adopts a two-layer “stacked” design (as shown in FIG. 3). The upper layer is a mixture of gravel and biochar, with a weight ratio of gravel to biochar of 1:1, and the lower layer is a mixture of gravel and bentonite, with a weight ratio of gravel to bentonite of 3:1; the biochar is 40-80 mesh straw biochar (purchased from Tanernuo New Materials).
A sixth layer: gravel drainage layer

Coarse gravel and drainage pipe network are used to provide an effective water flow channel to ensure water infiltration and control drainage to the municipal stormwater pipe network.
A seventh layer: anti-seepage geotextile lining layer

Bentonite-polyacrylamide composite geosynthetic clay liner (BPC-GCL): prepared by dry mixing 5% of polyacrylamide relative to dry bentonite.

The short-term experiment simulates a rainfall event with a total flow rate controlled at 500 L and a duration of 2 h. Sampling points are set at the inlet and outlet, and water samples are collected before, during, and after the experiment every 30 min. The removal rate is calculated according to the following formula:

$$Removal rate ( \% ) = ( \frac{Inlet concentration - Outlet concentration}{Inlet concentration} ) \times 100 \%$$

The results are shown in Table 1.

TABLE 1
Data of synthetic rainwater treatment in Example 1

| | Inlet | Outlet | |
|---|---|---|---|
| | concentration | concentration | Removal rate |
| | (mg/L) | (mg/L) | (%) |
| COD | 250 | 17.5 | 93 |
| BOD | 150 | 13.5 | 91 |
| Total nitrogen (TN) | 45 | 6.3 | 86 |
| Total phosphate (TP) | 10 | 1.2 | 88 |
| Copper (Cu) | 2 | 0.1 | 95 |
| Zinc (Zn) | 2 | 0.1 | 95 |

After six months of operation, the COD and BOD removal rates stabilized at over 90%, the nitrogen and phosphorus removal efficiencies exceeded 85%, and the heavy metal removal rate reached 95%.

Experiments have shown that the application of this system can improve the ecological value and leisure quality of sponge communities or parks, reduce the processing burden of urban drainage systems, and reduce long-term environmental maintenance costs.

The above descriptions are only preferred examples of the present invention. It should be noted that those of ordinary skill in the art can also make several improvements and modifications without departing from the principle of the present invention, and such improvements and modifications shall fall within the protection scope of the present invention.

What is claimed is:

1. A method for a sewage treatment and a new-generation urban rainstorm management, comprising using a bioretention pond integrating collection-filtration-purification functions, wherein the bioretention pond integrating collection-filtration-purification functions sequentially comprises, from top to bottom, an embedded composite microbial purification layer, a clay adsorption layer, a packing layer, and a gravel drainage layer, and further comprises a water retention layer, and a vegetation cover layer, and the vegetation cover layer and the water retention layer are sequentially stacked on the embedded composite microbial purification layer;
the embedded composite microbial purification layer comprises a first module layer and a second module layer; the first module layer and the second module layer form corresponding upper and lower layer structures in space; the first module layer is connected to the second module layer by an embedded unit column; the first module layer comprises a first microbial colony area, a second microbial colony area, and a third microbial colony area arranged in parallel; the second module layer is a fourth microbial colony area; and types of microbial species in the first microbial colony area, the second microbial colony area, the third microbial colony area, and the fourth microbial colony area are different;
the packing layer comprises a first packing layer and a second packing layer, wherein the first packing layer and the second packing layer are stacked; and the first packing layer and the second packing layer are different in packing type;
a thickness of the embedded composite microbial purification layer is more than or equal to 40 mm;
the first module layer and the second module layer both carry the microbial species by adopting support plates; and an activated carbon particle layer is laid on a support plate of the first module layer; and
clay used in the clay adsorption layer is attapulgite and bentonite-based clay.

2. The method according to claim 1, wherein when the bioretention pond integrating collection-filtration-purification functions is an impermeable bioretention pond, a geotextile lining layer is stacked on the gravel drainage layer.

3. The method according to claim 1, wherein packing materials used in the first packing layer and the second packing layer independently comprise gravel, bark mulch, biochar, or bentonite.

4. The method according to claim 2, wherein a geosynthetic liner used in the geotextile lining layer is a bentonite-based geotextile liner.
